(19) United States
(12) Patent Application Publication
(10) Pub. No.: US 2019/0256299 A1
(43) Pub. Date: Aug. 22, 2019

(54) METHOD FOR SETTING-UP A CONTAINER-MANUFACTURING SYSTEM, AND ASSOCIATED SYSTEM

(71) Applicant: SIDEL PARTICIPATIONS, OCTEVILLE-SUR-MER (FR)

(72) Inventors: Laurent DANEL, Octeville-sur-mer (FR); Franck FEILLOLEY, Octeville-sur-mer (FR); Stéphane LINGLET, Octeville-sur-mer (FR); Yves-Alban DUCLOS, Octeville-sur-mer (FR)

(21) Appl. No.: 16/341,239

(22) PCT Filed: Oct. 11, 2017
(86) PCT No.: PCT/FR2017/052786

§ 371 Date: Apr. 11, 2019

(30) Foreign Application Priority Data
Oct. 12, 2016 (FR) 1659846

(51) Int. Cl. B65G 47/84; B29D 22/00

(52) U.S. Cl. CPC B65G 47/846; B29K 2701/12; B29D 22/003

(57) ABSTRACT

Disclosed is a method for setting-up and adjusting a system including a conveying table, as well as a first and a second module. Also disclosed is a system, a first and a second module and a conveying table for transporting hollow bodies, including: at least two transfer wheels having an upstream-end transfer wheel and a downstream-end transfer wheel; and a rigid common chassis which rotatably supports all the transfer wheels via individual a rotational guide. Also disclosed is adjustment of the various transport elements with respect to one another because the setting-up of a system for the mass production of containers is an operation that requires precision so that the hollow bodies can circulate smoothly through the system.

### TECHNICAL FIELD OF THE INVENTION

The invention relates to the field of methods for setting up a container manufacturing system.

The invention relates to the field of container manufacturing systems, and in particular the systems comprising a conveying table for transporting hollow bodies, in particular preforms made of thermoplastic material, with the conveying table comprising:
A series of at least two transfer wheels having an upstream-end transfer wheel and a downstream-end transfer wheel, with each transfer wheel comprising hollow-body support elements on its periphery;
A rigid common frame that rotatably supports all of the transfer wheels by means of individual means for guiding in rotation, with the axes of rotation of the transfer wheels being held parallel by the frame, two adjacent transfer wheels being tangent.

### TECHNICAL BACKGROUND OF THE INVENTION

It is known to manufacture containers of thermoplastic material, such as bottles, by forming previously-heated preforms.

In the description and claims below, the term “hollow bodies” will be used to refer in a generic manner to the finished containers, the intermediate containers during processing (forming, labeling, filling), and the preforms. Each hollow body is equipped with a neck.

A system for the mass production of containers is formed by multiple modules that are arranged in such a way as to form a production line. Certain modules are formed by stations for processing hollow bodies. These processing stations are connected to one another either by air conveyors, with the containers being supported in the neck area, or by endless-belt conveyors, with the containers being supported by their bottoms. This type of manufacturing system has the major advantage of making possible a free arrangement of stations. However, it has the major drawback of taking up too much space on the ground.

Another type of system for the mass production of containers is formed by multiple modules that are arranged in such a way as to form a production line. Certain modules are formed by hollow-body processing stations, while other modules are formed by conveying tables connecting the processing stations to one another with a transporting of containers by their necks all along the production line.

In the description and claims below, the term module is applied to a set of elements that are supported by a frame, with the module being transported and deposited as a unit during the setting-up of the system.

The setting-up of a system for the mass production of containers is an operation that requires precision so that the hollow bodies can circulate smoothly through the system.

Concerning a system for mass production in which the hollow bodies circulate continuously, the conveying tables are designed in such a way as to hold the hollow bodies during their conveying. The hollow bodies are thus able to circulate at high speed without falling. For this purpose, the conveying tables generally comprise a series of transfer wheels, sometimes called star wheels, which are equipped on their periphery with individual support elements of hollow bodies, such as notches that support the neck of the hollow body. As a variant, the support elements are formed by, for example, clamps that grip the hollow body by its neck.

The transfer wheels of the conveying table are supported by a common frame, thus making possible the positioning of a single unit of all of the transfer wheels of the conveying table. Advantageously, the conveying table comprises a single drive element that puts into rotation all of the transfer wheels by means of transmission elements. The transmission elements make it possible to transmit the rotational movement in series between the adjacent transfer wheels.

During the setting-up of the system, the first step is generally to position the heaviest module and to secure it to the ground because it would be very complicated and inexpensive to correct the positioning of this module below. “Heavy” module is defined as a module that requires the use of bulky lifting instruments, such as a crane, to be able to be moved. This module will be called “reference module” below. It is generally the forming station that can weigh up to several tens of tons.

Once this reference module is positioned, the various modules are arranged successively, by following the path of circulation of the hollow bodies, starting from this reference module. Thus, a first conveying table is deposited on the ground exiting from the reference module. The position of the first conveying table is corrected in such a way as to be aligned with the reference module so that the hollow bodies exiting from said module can be picked up correctly by the first transfer wheel upstream from the conveying table. After correction of its positioning, the frame of this first conveying table is secured to the frame of the reference module.

Then, the next module is deposited on the ground exiting from the first conveying table. Its position is corrected in order to be aligned with the first conveying table, and then the module is secured. It involves, for example, a filling station or a labeling station.

The setting-up of the manufacturing system thus continues until the last module is installed. The position of each following module is corrected individually in relation to the position of the reference module.

The various modules traditionally comprise means for transporting preforms that are supported in a stationary manner by a frame of said module. The correction of the position of each module therefore requires moving the frame of the module as a unit. This is possible because of the relatively low weight of these modules in relation to the weight of the reference module. It is thus possible to correct the position of these modules to align them correctly with the preceding modules, for example by pushing the frame by means of mallets.

Nevertheless, it would be easier to be able to set up the manufacturing system without having to correct the position of all of the modules in relation to the position of the reference module.

In addition, it was recently proposed to integrate new modules into the manufacturing systems. These new modules have too significant a weight to make it possible to correct their position easily after having deposited them on the ground. It involves, for example, a station for coating hollow bodies.

Such a new module is, for example, installed downstream from the reference module with insertion of a conveying table to make possible the routing of the hollow bodies from one to the next. However, as painstaking as the depositing of the reference module and the depositing of the new module can be, there will always exist a lack of positioning of a module in relation to the other that will not make it possible to place the conveying table correctly in relation to one of these two modules.

To solve this problem, the document WO2012107172 proposes using transfer wheels that are supported by individual frames to replace the conventional conveying table comprising a frame that is common to all of the transfer wheels. Such an approach makes it possible to position correctly the end transfer wheels in relation to the two modules.

Nevertheless, such an approach requires positioning individually and vertically each of the transfer wheels in relation to one another so that they are all integrated in a horizontal plane, i.e., perpendicular to the axes of the transfer wheels, in order to carry out the transfer of hollow bodies. The installation time is therefore extended in relation to the installation of a unit of all of the transfer wheels that are supported by a common frame.

In addition, such an approach requires that each of the transfer wheels be put into motion by an individual motor. It is actually very complicated to use transmission elements between two successive transfer wheels because, due to the unevenness of the ground, the axes of rotation of the various transfer wheels supported by individual frames are no longer perfectly parallel in relation to one another. It thus becomes impossible to position correctly and in a simultaneous manner the transfer wheels between them, on the one hand, and the transmission elements, such as gears, between them, on the other hand. The cost of such an approach is very high because of the presence of several individual drive motors of each transfer wheel.

### BRIEF SUMMARY OF THE INVENTION

The invention proposes a method for setting up a container manufacturing system comprising at least a first module and a second module, and a conveying table that is inserted between the two modules to ensure the conveying of hollow bodies from a transport device for exit of hollow bodies of the first module to a transport device for entry of hollow bodies of the second module, characterized in that it successively comprises the following steps:
A first step of positioning two modules and securing them to the ground;
A second step of positioning the conveying table between the two modules, with the frame of the conveying table being positioned and secured in relation to a frame of one of the two modules;
A third step of adjusting the angular position of the adjustable transfer wheel of the conveying table in such a way as to make possible the transfer of hollow bodies between said transfer wheel up to the transport device of the other one of the two modules.

According to other characteristics of the setting-up method carried out according to the teachings of the invention:
During the third step, said adjustable wheel is placed along a path in the shape of an arc around the axis (F) of the adjacent transfer wheel (38F) between two end angular positions;
A fourth step of adjusting the height of the feet of the frame in such a way as to make possible the transfer of hollow bodies between said adjustable transfer wheel and the transport device of said other module;
The first module is a forming station;
The second module is a station for coating the hollow body;
The second module is a conveying table that is positioned and secured in relation to a frame of a station for coating the hollow body.

The invention also proposes a container manufacturing system comprising a first module, in particular a forming station;
A second module, in particular a station for coating the hollow body; and
A conveying table comprising a series of at least two transfer wheels each having, comprising support elements of the hollow body on its periphery, said series including:
   An upstream-end transfer wheel that is designed to be mounted tangent to a transport device for exit of said first module, and
   A downstream-end transfer wheel, each transfer wheel designed to be mounted tangent to a transport device for entry of said second module;
with the table also comprising a rigid common frame that rotatably supports all of the transfer wheels by means of individual means for guiding in rotation, with the axes (A to G) of rotation of the transfer wheels being kept parallel by the frame, two adjacent transfer wheels being tangent.

According to the invention, the guide means of at least one of the end transfer wheels, the so-called adjustable wheel, are mounted to slide horizontally in relation to the frame.

In other words, the conveying table is able to adapt to positioning defects of modules, quick to install and inexpensive to produce.

According to other characteristics of the conveying table produced according to the teachings of the invention:
The guide means of at least one of the end transfer wheels, the so-called adjustable wheel, are mounted to slide in relation to the frame along a path in the shape of an arc around the axis of the adjacent transfer wheel between two end angular positions—the conveying table comprises a single drive element that drives in rotation all of the transfer wheels in series by means of movement transmission elements;
Each adjustable transfer wheel is mounted integrally in rotation with a first coaxial gear that directly engages with a second gear that is mounted integrally in rotation coaxially with the adjacent transfer wheel;
The guide means of the transfer wheels other than the adjustable wheels are mounted in a unique non-adjustable position on the frame;
The frame comprises height-adjustable feet;
The conveying table comprises at least one intermediate transfer wheel that is inserted between the two end wheels;
The conveying table comprises a series of a number of intermediate transfer wheels that are inserted between the two end wheels;
A single end wheel is adjustable;
All of the transmission elements are formed by gears, each of which is mounted integrally in rotation coaxially with the associated transfer wheel, with each gear engaging directly with the associated gear of each adjacent wheel;
The conveying table comprises means for locking the guide means of the adjustable transfer wheel in relation to the frame in an adjusted angular position.

The invention also relates to the above-mentioned conveying table that is designed to be set up between a first module and a second module in order to transfer the hollow bodies from the first to the second module.

The invention also proposes a factory that comprises:
An installation area;
A first and a second module as well as a conveying table forming the hollow-body manufacturing system carried out according to the teachings of the invention;
The first and second modules as well as the conveying table are secured in the installation area of the factory to ensure good precision in setting up the conveying table and modules, in relation to one another.

### BRIEF DESCRIPTION OF THE FIGURES

Other characteristics and advantages of the invention will become clear from reading the following detailed description, for the understanding of which reference will be made to the accompanying drawings in which:

FIG. 1 is a plan view that shows a plan for installing on the ground a container manufacturing system comprising two processing stations and a conveying table;

FIG. 2 is a view that is similar to that of FIG. 1 in which the actual position of the two processing stations was superposed with their theoretical position that is defined by the installation plan of FIG. 1;

FIG. 3 is a view that is similar to that of FIG. 2 to which the actual position of the conveying table produced according to the teachings of the invention was added, with the table being positioned in relation to the first processing station;

FIG. 4 is a view that is similar to that of FIG. 3 in which the position of the downstream-end transfer wheel of the conveying table was adjusted to be tangent to an input transport device of the second processing station;

FIG. 5 is a perspective view that shows the conveying table that is produced according to the teachings of the invention;

FIG. 6 is a top view that shows the downstream-end transfer wheel of the conveying table of FIG. 5 and the adjacent transfer wheel;

FIG. 7 is an axial cutaway view along the cutting plane 7-7 of FIG. 6, which shows the guide means in rotation of the downstream-end transfer wheel;

FIG. 8 is a perspective view that shows the upper wall of a central beam of the frame of the conveying table at the downstream-end transfer wheel;

FIG. 9 is a cutaway view along the cutting plane 9-9 of FIG. 1, which shows means for locking the downstream-end transfer wheel in a determined position;

FIG. 10 is a perspective view that shows a drive element of the transfer wheels of the conveying table;

FIG. 11 is a block diagram that shows a method for setting up a container manufacturing system comprising a conveying table that is produced according to the teachings of the invention.

### DETAILED DESCRIPTION OF THE FIGURES

In the description below, elements having an identical structure or similar functions will be referred to by the same references.

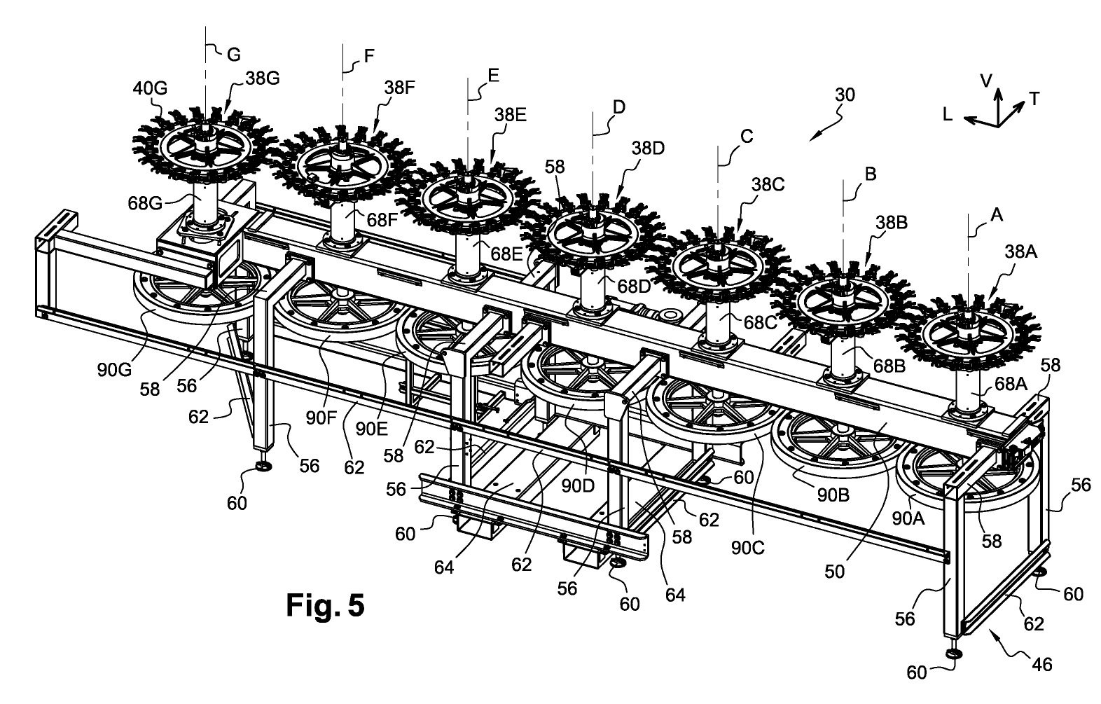

In the description below, the following orientations will be adopted in a non-limiting manner:
Longitudinal, directed from back to front and indicated by the allow “L” of FIGS. 5 to 10;
Vertical, directed from bottom to top and indicated by the arrow “V” of FIGS. 5 to 10;
Transversal, directed from left to right and indicated by the arrow “T” of FIGS. 5 to 10.

The term “horizontal” will be used to define a plane that is orthogonal to the vertical direction. The vertical direction is defined by way of a purely geometric reference, and it is not necessarily confused with the direction of gravity.

The terms upstream and downstream will be used in reference to the direction of movement of the hollow bodies along a path through the container manufacturing system.

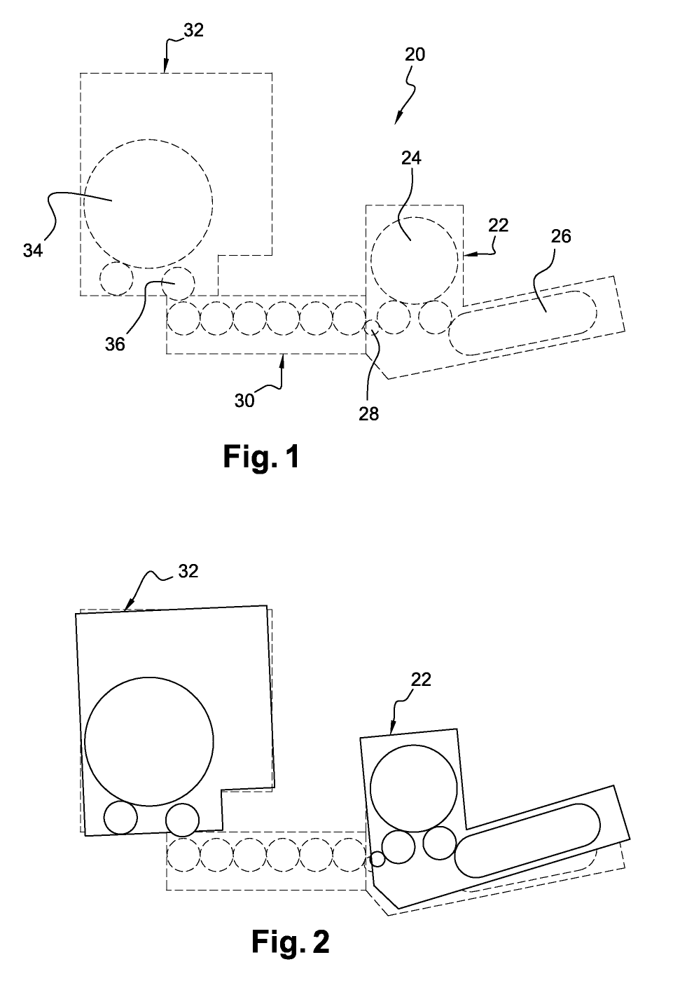

The theoretical plan of installing a mass-production container manufacturing system 20 on the ground was shown diagrammatically in FIG. 1. In the system shown in FIG. 1, the hollow bodies are designed to be moved in a continuous manner from their entry into the system 20 up to their exit.

The system 20 comprises multiple modules, each of which is designed to be installed as a unit. For this purpose, each module comprises a single support frame. The frame of a module is designed to be able to be transported and deposited as a single unit on the ground, in a position that is determined by the installation plan.

In the example shown in FIG. 1, a first module is formed by a forming station 22. The forming station 22 comprises a carrousel 24 for forming previously-heated preforms. The carrousel 24 is supported by the frame of the forming station 22. The carrousel 24 supports a number of molding units (not shown) that are intended to shape the preforms into containers by forming by means of a pressurized fluid, in particular air. During the forming operation, the carrousel 24 rotates in such a way as to move the hollow bodies continuously from a loading point of a hot preform up to an unloading point of the final container. Such a carrousel 24 is well known to one skilled in the art. It will therefore not be described in more detail.

A furnace 26 for thermal conditioning of preforms is juxtaposed here with the forming station 22. This is a heating tunnel that is traversed by a series of gripping elements (not shown), each of which is able to support a preform. The preforms are thus heated during their conveying through the heating tunnel from an entry point of the cold preforms up to a transfer point of hot preforms in the direction of the forming carrousel 24. Such a conditioning furnace 26 is well known to one skilled in the art. It will therefore not be described in more detail below.

The hollow bodies continuously exit from the forming station 22 by means of an output transport device 28 that is supported by the frame of the forming station 22. The output transport device 28 is formed here by a transfer wheel that is driven in rotation around an essentially vertical axis. The transfer wheel comprises on its periphery individual support elements (not shown) of hollow bodies.

Another module is arranged directly downstream from the forming station 22. This is a conveying table 30. The conveying table 30 will be described in more detail later. It is able to pick up the hollow bodies exiting from the forming station 22 by means of the output transport device 28 in order to transport them to a next second downstream module.

The second downstream module is formed here, in a non-limiting manner, by a station 32 for coating hollow bodies with a so-called “barrier” layer. The coating station 32 comprises a processing carrousel 34 that is supported by a frame of the coating station 32. The hollow bodies are routed continuously to the processing carrousel 34 by means of an input transport device 36. The input transport device 36 is formed here by a transfer wheel that is driven in rotation around an essentially vertical axis. The transfer wheel comprises on its periphery individual support elements of hollow bodies.

In FIGS. 1 to 4, the theoretical positions of the modules are indicated in dashes, while their actual position is indicated in continuous lines.

As shown in FIG. 2, when the modules are deposited on the ground, it is common that their actual position, indicated in solid lines, does not line up perfectly with their theoretical position that is defined by the installation plan, indicated by dashes. A longitudinal offsetting, a transverse offsetting, as well as an angular offsetting are thus observed in relation to the theoretical position. These offsets are, to the extent possible, limited to a certain tolerance range.

In addition, based on the state of the ground, it is also common for the plate of the modules not to be perfectly horizontal. In addition, the slope of the modules on the ground may differ from one module to the next according to the state of the ground.

Certain modules weigh too much, for example up to multiple tens of tons, to be able to be moved after being deposited on the ground. The other modules should therefore be positioned in relation to the actual position of these modules.

This is in particular the case of the forming station 22 and the coating station 32 that can each weigh up to 30 tons each.

As a result, the conveying table 30 is to be able to adapt to the positioning tolerances of these two stations 22, 32. In the following figures, a conveying table 30, produced according to the teachings of the invention making it possible to adapt to the tolerances of positioning of the stations 22, 32 without having to correct the positioning of these two stations 22, 32, is shown.

As shown in FIG. 5, the conveying table 30 comprises a series of at least two transfer wheels 38A, 38G having an upstream-end transfer wheel 38A and a downstream-end transfer wheel 38G.

According to its length, the conveying table 30 can comprise at least one intermediate transfer wheel that is inserted between the two end wheels 38A, 38G. The hollow bodies thus move by passing successively through each of the transfer wheels 38A to 38G.

In the embodiment that is shown in FIG. 5, the conveying table 30 comprises a series of seven identical transfer wheels 38A, 38B, 38C, 38D, 38E, 38F, 38G. We will describe below the downstream-end transfer wheel 38G, with this description being applicable to the other transfer wheels 38A to 38F of the conveying table 30.

Below, the references of an element associated with a particular transfer wheel will be followed by a letter that is associated with this transfer wheel.

The transfer wheel 38G extends into a horizontal plane, and it comprises a central vertical axis “G” of rotation that is perpendicular to said horizontal plane. The axes of rotation of each transfer wheel 38A to 38G will be referred to respectively by the references “A” to “G.”

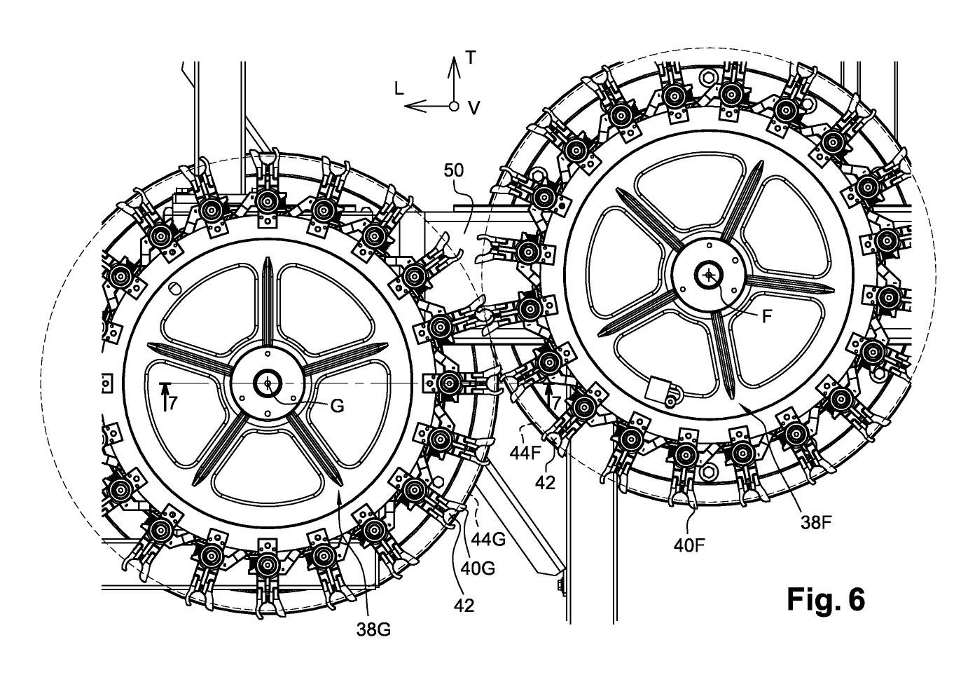

As shown in more detail in FIG. 6, the transfer wheel 38G comprises hollow-body support elements 40G on its periphery. The support elements 40G here are 20 in number. They are distributed uniformly around the wheel 38G. Each support element 40G is able to support a hollow body individually and to keep it in position during its transport.

In the embodiment shown in the figures, each support element 40G is formed by a clamp that is able to grasp the hollow body by its neck.

The point between two jaws of the clamp that corresponds to the position of an axis of the neck (not shown) of the hollow body when it is gripped by the clamp will be called center 42 of the clamp. Below, reference circle 44G will be called a circle that is centered on the axis of rotation of the transfer wheel 38G that passes through the center of the clamps of said transfer wheel 38G.

The conveying table 30 also comprises a rigid common frame 46 that rotatably supports—around their axes “A” to “G”—all of the transfer wheels 38A to 38G by means of individual means for guiding in rotation.

“Rigid” frame will be understood to mean that the frame 46 does not deform much during its transport. The frame 46 is not particularly articulated. This frame is secured to the ground of the factory during the setting-up of the system 20.

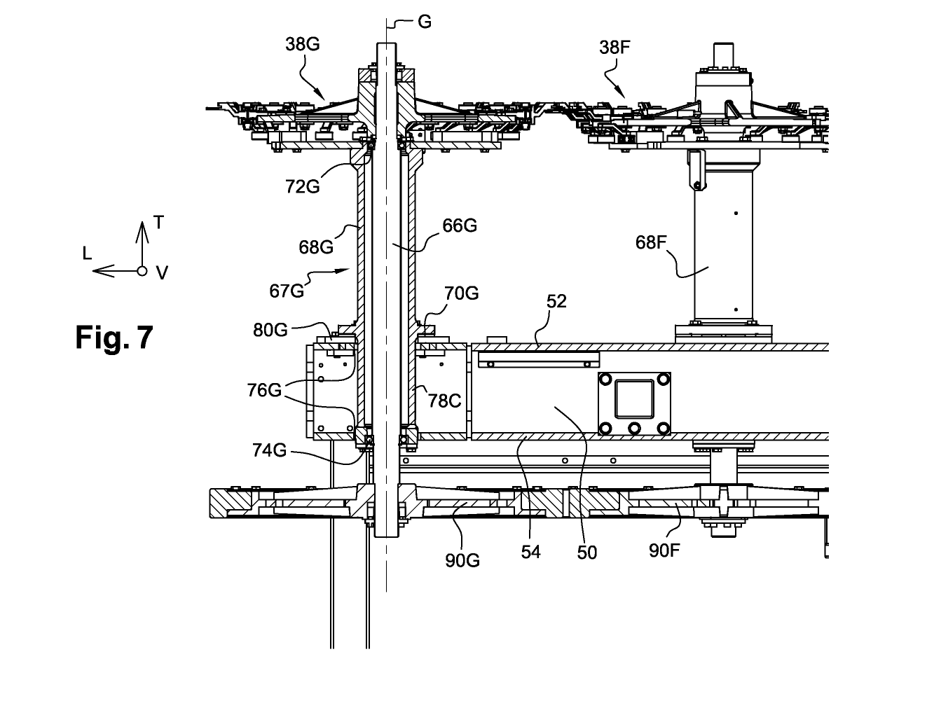

More specifically, the frame 46 comprises a central beam 50 with an essentially longitudinal axis having a great rigidity. The beam 50 is hollow here with a square or rectangular cross-section. It thus comprises an upper wall 52 and a lower wall 54 that are separated by a free inside space as is shown in FIG. 7.

The beam 50 is supported by multiple feet 56 that are distributed over the length of the beam 50 and on either side of the axis of the beam 50. The feet 56 are vertical here. They are 8 in number here, distributed in four left feet 56 and four right feet 56.

To make it possible for the frame 46 to rest on the ground in a stable manner, the feet 56 are separated transversely from the longitudinal axis of the beam 50. For this purpose, the upper end of each foot 56 is connected rigidly to the beam 50 by means of a crosspiece 58. Each foot 56 comprises—at its lower end—a pad 60 that can be adjusted in height to make it possible for all of the feet 56 to rest simultaneously on the ground independently of its rough spots and to make it possible to adjust the plate of the conveying table 30.

To make possible a greater rigidity of the frame 46, the feet 56 are connected to one another by small support beams 62. The rigidity of the frame 46 is thus designed in order to make possible its transport as a single unit and to position it in a single operation at the location provided by the installation plan.

For this purpose, the frame 46 here comprises two transverse cases 64 that are arranged at the bottom part of the feet 56. The cases 64 are more specifically arranged in such a way as to be distributed on either side of the center of gravity of the conveying table 30. The cases 64 are separated longitudinally from one another by a suitable distance so that a forklift truck can set up the cases 64 and transport the conveying table 30 as a unit.

The transfer wheels 38A to 38G are supported by the central beam 50 in such a way that their axes “A” to “G” of rotation are vertical. The rigidity of the beam 50 and the frame 46 in general is sufficient to ensure that the axes “A” to “G” of the transfer wheels 38A to 38G will remain parallel to one another independently of the rough spots of the ground and perpendicular to the horizontal plane that is defined by the transfer wheels.

As shown in FIG. 7, each transfer wheel 38A to 38G is mounted integrally in rotation with a coaxial central shaft 66A to 66G. Each shaft 66A to 66G is accommodated in rotation in individual guide means 67A to 67G in rotation, which are supported by the beam 50. These guide means 67A to 67G in rotation are similar for all of the transfer wheels 38A to 38G. Therefore, only the means 67G that are associated with the downstream-end transfer wheel 38G will be described.

The means 67G for guiding in rotation comprise a sleeve 68G with a vertical axis that is designed to be mounted in a stationary manner on the beam 50. An upper end of the sleeve 68G is located just below the transfer wheel 38G. The sleeve 68G comprises a flange 70G that extends radially projecting toward the outside and that rests on the upper wall 52 of the beam 50.

The sleeve 68G coaxially accommodates the shaft 66G of the transfer wheel 38G with a play that allows the shaft 66G to rotate in relation to the sleeve 68G. The shaft 66G rests on the sleeve 68G by means of at least one guide bearing 72G, here a ball bearing. This first guide bearing 72G is arranged here in the upper end of the sleeve 68G.

A second guide bearing 74G, here a ball bearing, completes the guiding in rotation of the wheel shaft 66G. The second guide bearing 74G is arranged here in a lower end of the sleeve 68G.

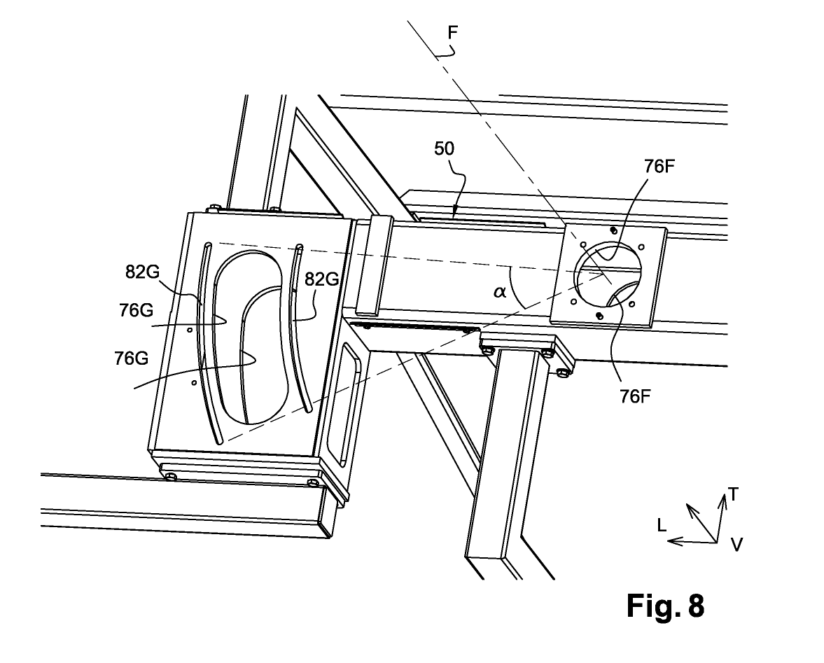

The shaft 66G passes through the beam 50 vertically here on either side for the benefit of a passage opening 76G passing through the upper wall 52 and the lower wall 54 of the beam 50, as is shown in FIG. 8. In referring to FIG. 7, a lower end section 78G of the sleeve 68G extending downward from the flange 70G penetrate here into the passage opening 76G by passing through the beam 50 completely [sic]. In this manner, the sleeve 68G is kept vertical in a firm and rigid manner by the edges of the passage opening 76G both in the upper wall 52 and in the lower wall 54 of the beam 50.

The transfer wheels 38A to 38G are arranged successively in series along the longitudinal axis of the beam 50. Thus, each upstream transfer wheel 38A to 38F is adjacent to a downstream wheel 38B to 38G that is directly next.

To make possible the transfer of hollow bodies from one transfer wheel 38A to 38F to the next, two successive transfer wheels are tangent in horizontal projection.

As is shown in FIG. 6, with, for example, the downstream-end transfer wheel 38G and the adjacent wheel 38F at the point of tangency between the two transfer wheels 38F, 38G, each support element 40F of the upstream transfer wheel 38F can be aligned vertically with a corresponding support element 40G of the downstream transfer wheel 38G in such a way that the neck of the hollow body is supported simultaneously by the two lined-up support elements 40G, 40F. For this purpose, the support elements 40G of a wheel 38G are slightly offset vertically, in the direction of the height, in relation to the support elements 40F of the adjacent wheels 38F to prevent any interference between them during the passage to the point of tangency.

Concerning transfer wheels 38A to 38G that are equipped with clamps, two transfer wheels 38F, 38G are said to be tangent when their reference circles 44G, 44F are tangent, as illustrated in FIG. 6.

When they are formed by clamps, the support elements 40F of the upstream transfer wheel 38F are controlled in the open position to allow the hollow bodies to depart on the downstream transfer wheel 38G when they pass the point of tangency.

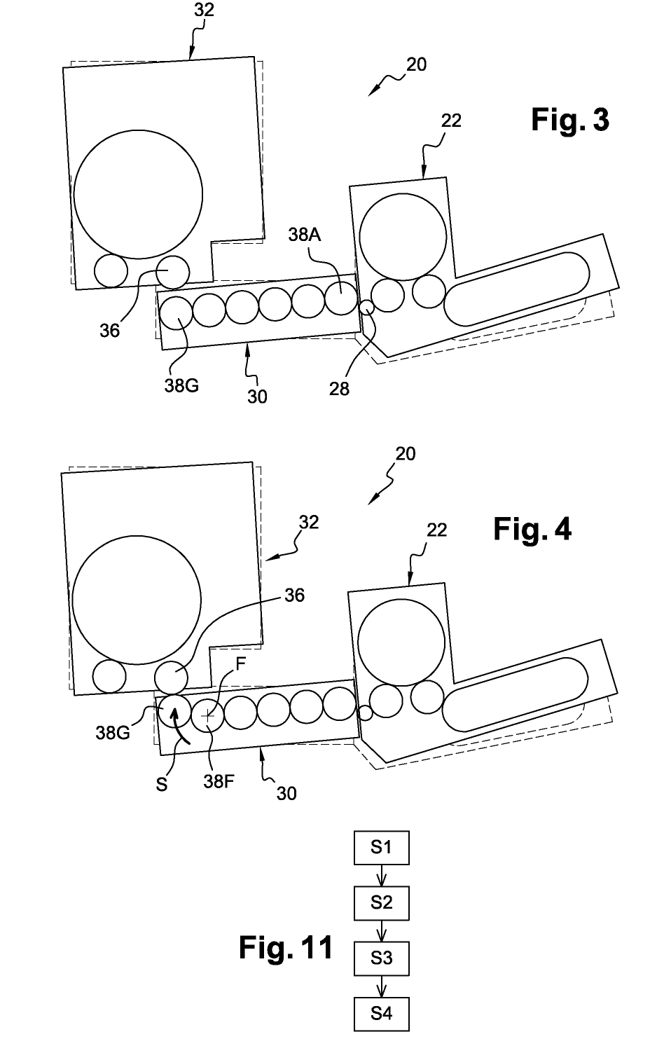

As is shown in FIG. 3, when the conveying table 30 is deposited on the ground in the location that is defined by the installation plan between the two stations 22, 32 occupying their actual position, the conveying table 30 can only be placed correctly in relation to one of the two stations 22, 32.

Consequently, one of the end transfer wheels 38G of the conveying table 30 runs the risk of not being positioned correctly in relation to the output or input transport device 28, 36 of the other processing stations 22, 32.

The position of the conveying table 30 is corrected here in relation to the forming station 22. It is noted in FIG. 3 that the downstream-end transfer wheel 38G of the conveying table 30 is not tangent to the transfer wheel forming the input transport device 36 of the coating station 32.

To solve this problem by not having to move either of the two processing stations 22, 32, the means 67G for guiding in rotation at least one of the end transfer wheels 38G, the so-called adjustable transfer wheel, are mounted to slide horizontally in relation to the frame 46.

The term “horizontally” is understood as a horizontal plane that is defined by a perpendicular to an axis of one of the transfer wheels. Preferably, each of the perpendiculars of each axis is common to the horizontal plane. Inscribed in this horizontal plane is the path of a portion of the hollow bodies, in particular the neck.

In particular, at least one of the end transfer wheels 38G, the so-called adjustable transfer wheel, is mounted to slide horizontally in relation to the frame 46 along a path in the shape of an arc around the axis “F” of the adjacent transfer wheel 38F between two end angular positions.

The path in the shape of an arc and the parallelism of the axes of rotation of these two transfer wheels 38F, 38G make it possible to ensure that the end transfer wheel 38G remains permanently tangent to the adjacent transfer wheel 38F regardless of the angular position of its means 67G for guiding in rotation between its two end angular positions.

It is thus possible to make the end transfer wheel 38G slide up to a so-called adjusted angular position in which the hollow bodies can be transferred smoothly between the end transfer wheel 38G and the input or output transport device 28, 36 of the associated processing station 22, 32, as is illustrated by the arrow “S” of FIG. 4.

In the example that is shown in FIGS. 5 to 10, only the means 67G for guiding in rotation the downstream-end transfer wheel 38G can be adjusted. The means 67A to 67F for guiding in rotation all of the other transfer wheels 38A to 38F occupy a stationary position in relation to the frame 46. Below, the downstream-end transfer wheel 38G will therefore be called an adjustable transfer wheel 38G.

As a variant of the invention, not shown, the two downstream-end and upstream-end transfer wheels are adjustable. This makes it possible to avoid having to correct specifically the position on the ground of the frame of the conveying table to ensure the smooth transfer of the preforms between the processing stations and the conveying table 30.

According to another variant of the invention, not shown, only the means for guiding the upstream-end transfer wheel in rotation can be adjusted in position in relation to the frame.

To make possible the adjustment in angular position of the means 67G for guiding the adjustable transfer wheel 38G, as is illustrated in FIG. 8, the passage openings 76G of the corresponding beam 50 have an elongated shape in an arc that is centered on the axis “F” of rotation of the adjacent transfer wheel 38F to make possible the sliding of the guide means 67G in rotation. The passage opening 76G extends over an angular sector “a,” and thus, for example, approximately 30°.

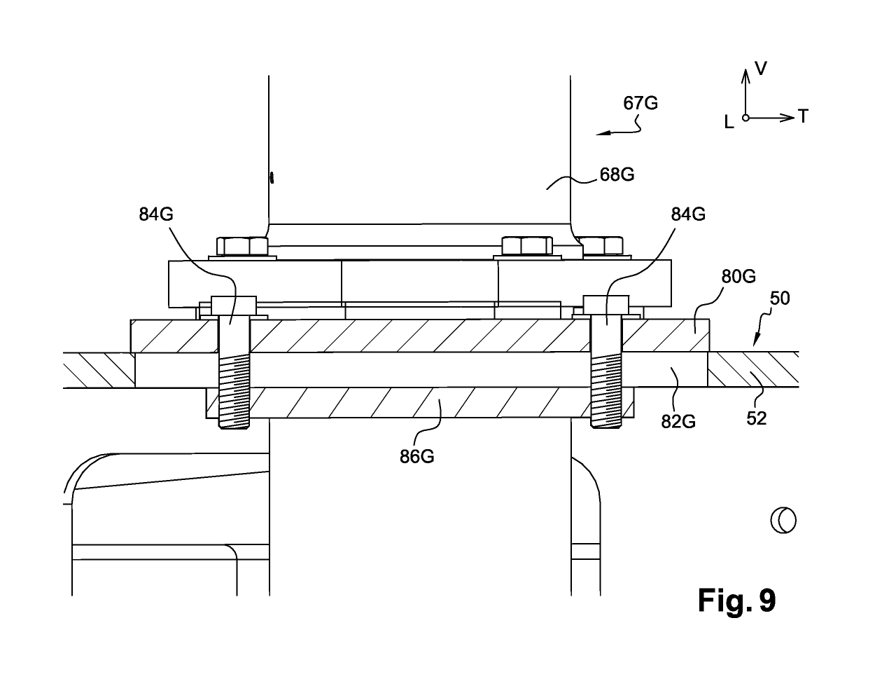

By referring to FIGS. 7 and 9, the flange 70G of the sleeve 68G of said adjustable transfer wheel 38G rests on the upper wall 52 of the beam 50 by means of a horizontal support plate 80G.

Means for locking the guide means 67G of the adjustable transfer wheel 38G in relation to the frame 46 in an adjusted angular position are also provided. The locking is carried out by tightening the support plate 80G against the beam 50.

For this purpose, the support plate 80G comprises holes that are arranged lined up with two slots 82G in the shape of an arc that is concentric with the arc formed by the passage opening 76G for the passage of screws 84G through the beam 50. The screws 84G are accommodated in matching plates 86G that are vertically arranged opposite the support plate 80G inside of the beam 50, as shown in FIG. 9. The screws 84G make it possible to tighten the upper wall 52 of the hollow beam 50 between the support plate 80G and the matching plates 86G in order to lock the sleeve 68G, and therefore to lock the guide means 67G in an angular position that is selected between the two end angular positions.

The tightening of the screws 84G is, for example, ensured by a tapping of the matching plates 86G or by a nut that is accommodated under the matching plates 86G.

When an operator desires to modify the angular position of the adjustable transfer wheel 38G, it is thus enough to untighten the screws 84G to release the pressure of the plates 80, 86 and to allow the guide means 67G to slide in rotation to the desired position.

The means 67A to 67F for guiding in rotation transfer wheels 38A to 38F, other than the adjustable wheels, are mounted in a unique non-adjustable position on the frame 46. All of the other transfer wheels 38A to 38F thus cannot be adjusted. For this purpose, the associated sleeve 68A to 68F is accommodated in a passage opening 76A to 76F having a complementary contour, circular here, not making it possible to change the position of the sleeve 68A to 68F, and therefore of the transfer wheel 38A to 38F, in relation to the frame 46, as illustrated in FIG. 8.

In a known manner, two consecutive transfer wheels rotate in the reverse direction in a synchronized manner so that each support element 40 is lined up with a corresponding support element 40 of the downstream transfer wheel at the point of tangency.

Advantageously, the table comprises a single drive element 88 that drives in rotation all of the transfer wheels 38A to 38G in series by means of movement transmission elements [sic].

For this purpose, at least the adjustable transfer wheel 38G is mounted integrally in rotation with a first coaxial gear 90G that engages directly with a second gear 90F that is mounted integrally in rotation coaxially with the adjacent transfer wheel 38F, as is illustrated in FIGS. 5 and 7. Each gear 90F, 90G is mounted integrally in rotation on a lower section of the associated shaft 66. Said lower section of the shaft 66 extends vertically downward outside of the sleeve 68 below the central beam 50.

Because of this arrangement, when the means 67G for guiding in rotation the adjustable transfer wheel 38G slide along their path in the shape of an arc, the transfer wheel 38G, the shaft 66G, and the gear 90G move together along said path in the shape of an arc.

The two gears 90F, 90G have a pitch circle that is essentially equal to the diameter of the reference circle 44F, 44G of the transfer wheels 38F, 38G. Thus, regardless of the angular position of the sleeve 68G of the adjustable transfer wheel 38G along its passage opening 76G in the shape of an arc, the gear 90G of the adjustable transfer wheel 38G remains engaged correctly with the gear 90F of the adjacent transfer wheel 38F.

In the embodiment shown in FIGS. 5 to 10, all of the transfer wheels 38A to 38G comprise a gear 90A to 90G that is identical to the one that is described for the adjustable transfer wheel 38G. Thus, putting any transfer wheel 38A to 38F of the conveying table 30 into rotation drives all of the other transfer wheels 38A to 38G of the conveying table 30 in rotation in a synchronized manner.

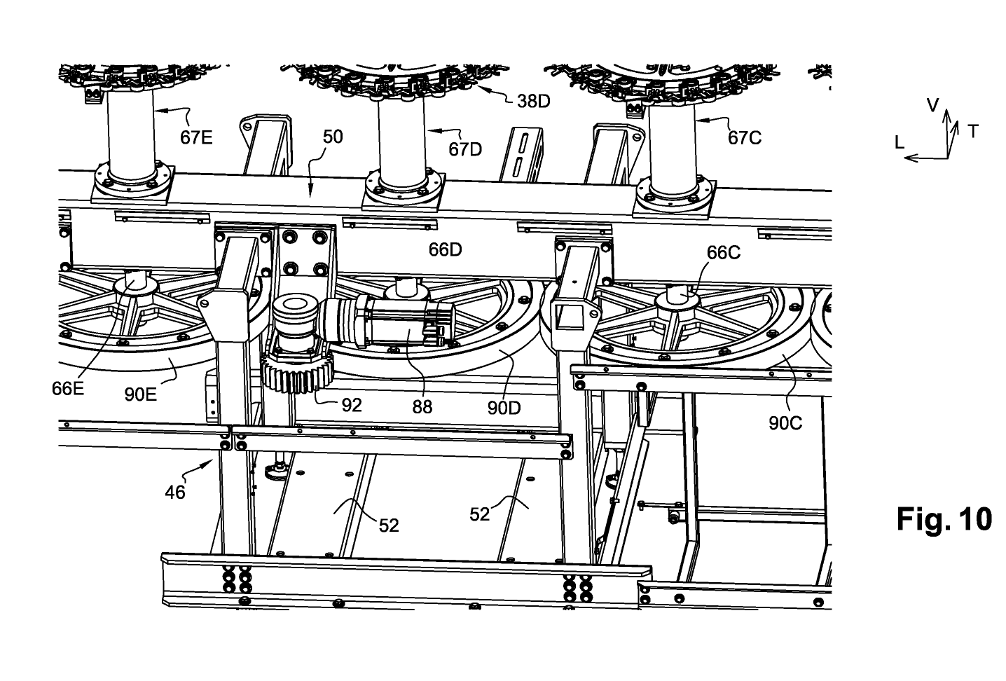

As shown in FIG. 10, the drive element 88 is formed by a motor, here an electric motor, which drives in rotation a drive gear 92. The drive element 88 is supported by the central beam 50. The drive gear 92 is engaged with the gear 90D of one of the non-adjustable transfer wheels, here the intermediate transfer wheel 38D.

The transmission elements 90A to 90G are not designed to be linked to transmission elements of another module. The offsets of position between two modules due in particular to rough spots of the ground do not make it possible to ensure that the axes of rotation “A” to “G” of the transfer wheels of the conveying table 30 will be sufficiently parallel with the axes of rotation of the transfer wheels of the other modules. As a result, the engagement of the transmission elements 90A to 90G of the conveying table 30 is liable not to be able to be linked to the transmission elements of other modules. Thus, the drive element 88 is designed to drive only the transfer wheels 38A to 38G of the conveying table 30.

As a variant, it will be understood that the gears can be replaced by other known movement-synchronized transmission means, such as belts and pulleys.

A method for setting up the container manufacturing system 20 that was described above and that is illustrated in FIG. 11 is now described.

During a first step “S1,” the first module, formed here by the forming station 22, and the second module, formed by the coating station 32, are deposited on the ground in the location that is provided by the installation plan. As explained above with reference to FIG. 2, the two processing stations 22, 32 are slightly offset in relation to the theoretical position that is defined by the plan. These two stations 22, 32 are then secured to the ground.

Then, during a second step “S2,” the conveying table 30 is deposited as a unit between the two processing stations 22, 32 in the location that is provided by the installation plan, as is shown in FIG. 3. With the conveying table 30 having a single adjustable transfer wheel 38G that is formed by the adjustable transfer wheel 38G, the position of the frame 46 of the conveying table 30 is corrected in relation to the actual position of the forming station 22. In this corrected position, the upstream-end transfer wheel 38A of the conveying table 30 is tangent to the transfer wheel forming the output transport device 28 of the forming station 22. The frame 46 of the conveying table 30 is then secured to the frame of the forming station 22.

In this corrected position, the adjustable transfer wheel 38G of the conveying table 30 is not tangent to the transfer wheel forming the input transport device 36 of the coating station 32, in particular because of the various tolerances of position of the modules.

Then, during a third adjustment step “S3,” the angular position of the adjustable transfer wheel 38G of the conveying table 30 is adjusted by the sliding of means 67 for guiding in rotation said adjustable transfer wheel 38G in relation to the beam 50, as indicated by the arrow “S” of FIG. 4. The adjustable transfer wheel 38G is thus slid to an adjusted position in which the hollow bodies can be transferred automatically from said adjustable transfer wheel 38G to the input transport device 36 of the coating station 32. In its adjusted position, the adjustable transfer wheel 38G is thus tangent to the transfer wheel forming the input transport device 36 of the coating station 32.

Finally, during a fourth step “S4” for adjusting the height that can take place before the third step “S3,” during the third step “S3,” or after the third step “S3,” the pads 60 of the frame 46 are adjusted in height in such a way as to make possible the transfer of hollow bodies from said adjustable transfer wheel 38G to the input transport device 36 of the coating station 32.

As a variant of the invention, not shown, a second conveying table is inserted between the conveying table 30 that is produced according to the teachings of the invention and the coating station 32. This second conveying table is, for example, a conveying table with non-adjustable transfer wheels. In this case, the position of the second conveying table is corrected in relation to the position of the coating station 32. The adjustable transfer wheel 38G of the first conveying table 30 that is produced according to the teachings of the invention makes it possible to position the adjustable transfer wheel 38G in a tangent manner in relation to a non-adjustable upstream-end transfer wheel of the second conveying table.

The conveying table 30 that is produced according to the teachings of the invention preserves the advantages of a unique and rigid frame 46 that makes it possible to transport the conveying table 30 as a unit. In this way, the positioning of the conveying table 30 is fast.

In addition, the conveying table 30 that is produced according to the teachings of the invention makes it possible to compensate for the positioning errors of an upstream module and a downstream module without looking to correct the position of either of these two modules. This is particularly useful when the two upstream and downstream modules are too heavy to be able to be moved without using a lifting instrument.

This also makes it possible to reduce the setting-up time of a conventional system 20, because it is no longer necessary to correct the position of all of the modules, even when the modules are light enough to be moved without using a crane.

A factory will now be described that comprises:
An installation area;
A first and second module, as well as a conveying table forming the hollow-body manufacturing system that is produced according to the teachings of the invention;
The first and second modules, as well as the conveying table, are secured in the installation area of the factory to ensure good precision in setting up the conveying table and modules, in relation to one another.

1. Method for setting up a container manufacturing system (20) comprising at least a first module, a second module, and a conveying table (30) that is inserted between the two modules to ensure the conveying of hollow bodies from a transport device (28) for exit of the hollow bodies of the first module to a transport device (36) for entry of the hollow bodies of the second module,
with the conveying table comprising:
A series of at least two transfer wheels (38A to 38G) having an upstream-end transfer wheel (38A) and a downstream-end transfer wheel (38G);
A rigid common frame (46) that rotatably supports all of the transfer wheels (38A to 38G), with two adjacent transfer wheels (38A to 38G) being tangent;
The means (67A to 67G) for guiding at least one of the end transfer wheels (38G), the so-called adjustable wheel, are mounted to slide horizontally in relation to the frame (46),
with the setting-up method successively comprising the following steps:
A first step (S1) for positioning two modules and securing them to the ground;
A second step (S2) for positioning the conveying table (30) between the two modules, with the frame (46) of the conveying table (30) being positioned and secured in relation to a frame of one of the two modules; and
a third step (S3) for adjusting said adjustable wheel by horizontal sliding in such a way as to make possible the transfer of hollow bodies between said adjustable wheel (38G) to the device (36) for transport of the other one of the two modules.

2. Method according to claim 1, wherein during the third step, said adjustable wheel is moved along a path in the shape of an arc around the axis (F) of the adjacent transfer wheel (38F) between two end angular positions.

3. Method according to claim 1, further comprising a fourth step (S4) for adjusting the height of the feet (56) of the frame (46) in such a way as to make possible the transfer of hollow bodies between said adjustable transfer wheel (38G) and the transport device (36) of said other module.

4. Method according to claim 1, wherein the first module is a forming station (22).

5. Method according to claim 1, wherein the second module is a station (32) for coating the hollow body.

6. Method according to claim 1, wherein the second module is a conveying table that is positioned and secured in relation to a frame of a station (32) for coating the hollow body.

7. System (20) for manufacturing hollow bodies, in particular preforms (14), of thermoplastic material, comprising:
A first module (22), in particular a forming station:
A second module (36), in particular a station for coating the hollow body; and
A conveying table (30) comprising a series of at least two transfer wheels (38A to 38G) each having, comprising hollow-body support elements (40A to 40G) on its periphery, said series including:
An upstream-end transfer wheel (38A) that is designed to be mounted tangent to a transport device (28) for exit of said first module (22), and
A downstream-end transfer wheel (38G), each transfer wheel (38A to 38G) designed to be mounted tangent to a transport device (28) for entry of said second module (36);
with the table also comprising a rigid common frame (46) that rotatably supports all of
the transfer wheels (38A to 38G) by means of individual means (67A to 67G) for guiding in rotation, with the axes (A to G) of rotation of the transfer wheels (38A to 38G) being kept parallel by the frame (46), two adjacent transfer wheels (38A to 38G) being tangent;
wherein the means (67A to 67G) for guiding at least one of the end transfer wheels (38G), the so-called adjustable wheel, are mounted to slide horizontally in relation to the frame (46).

8. Hollow-body manufacturing system (20) according to claim 7, wherein the means of said adjustable wheel are mounted to slide in relation to the frame (46) along a path in the shape of an arc around the axis (F) of the adjacent transfer wheel (38F) between two end angular positions.

9. Hollow-body manufacturing system (20) according to claim 8, wherein the table (30) comprises a single drive element (88) that drives in rotation all of the transfer wheels (38A to 38G) in series by means of movement transmission elements (90A to 90G).

10. Hollow-body manufacturing system (20) according to claim 9, wherein each adjustable transfer wheel (38G) is mounted integrally in rotation with a first coaxial gear (90G) that engages directly with a second gear (90F) that is mounted integrally in rotation coaxially with the adjacent transfer wheel (38F).

11. Hollow-body manufacturing system (20) according to claim 7, wherein the means (67A to 67F) for guiding transfer wheels (38A to 38F) other than the adjustable wheels (38G) are mounted in a unique non-adjustable position on the frame (46).

12. Hollow-body manufacturing system (20) according to claim 11, wherein the frame (46) comprises height-adjustable feet (56).

13. Hollow-body manufacturing system (20) according to claim 7, wherein the conveying table (30) comprises at least one intermediate transfer wheel (38B to 38F) that is inserted between the two end wheels (38A, 38G).

14. Hollow-body manufacturing system (20) according to claim 13, wherein the conveying table (30) comprises a series of a number of intermediate transfer wheels (38B to 38F) that are inserted between the two end wheels (38A, 38G).

15. Hollow-body manufacturing system (20) according to claim 7, wherein a single end wheel (38G) is adjustable.

16. Hollow-body manufacturing system (20) according to claim 7, character wherein all of the transmission elements (90A to 90G) are formed by gears, each of which is mounted integrally in rotation coaxially with the associated transfer wheel (38A to 38G), with each gear engaging directly with the associated gear of each adjacent wheel.

17. Hollow-body manufacturing system (20) according to claim 7, further comprising means (80G, 84G, 86G) for locking the guide means (67G) of the adjustable transfer wheel (38G) in relation to the frame (46) in an adjusted angular position.

18. Method according to claim 2, wherein the first module is a forming station.

19. Method according to claim 3, wherein the first module is a forming station

20. Method according to claim 2, wherein the second module is a station for coating the hollow body.
